(19) United States
(12) Patent Application Publication
(10) Pub. No.: US 2009/0279279 A1
(43) Pub. Date: Nov. 12, 2009

(54) LIGHT EMITTING DEVICE AND A MANUFACTURING METHOD THEREOF

(75) Inventor: Pai-Shen HSUEH, Taipei City (TW)

Correspondence Address: RABIN & Berdo, PC, 1101 14TH STREET, NW, SUITE 500, WASHINGTON, DC, 20005, US

(73) Assignees: SILITEK ELECTRONIC (GUANGZHOU) CO., LTD., Guangzhou (CN); LITE-ON TECHNOLOGY CORPORATION, Taipei City (TW)

(21) Appl. No.: 12/360,274

(22) Filed: Jan. 27, 2009

(30) Foreign Application Priority Data
May 9, 2008 (CN) 200810028055.8

(51) Int. Cl. F21V 9/08

(52) U.S. Cl. 362/84; 362/293

(57) ABSTRACT

A light emitting device includes a light emitting body, a base for carrying the light emitting body, an encapsulating material covering the light emitting body and a wavelength conversion material mixing with the encapsulating material. The concentration of wavelength conversion material is characterized by the fact that the concentration of the wavelength conversion material is higher at the higher space that is further from the light emitting body located at the bottom of the light emitting device. Accordingly, the reflection rate of the mixture mixed with the encapsulating material and the wavelength conversion material has gradual variation, and the total reflection on the boundary is reduced thus improves the illumination efficiency.

### BACKGROUND OF THE INVENTION

1. Field of the Invention

The present invention relates to a structure of a light emitting device and a manufacturing method thereof. The present invention in particular relates to a light emitting device with high illumination efficiency and a manufacturing method thereof.

2. Description of Related Art

Lighting apparatus sometimes has problems of low illuminating efficiency due to the packaging structure of the lighting apparatus. For solving this problem, particular steps are applied in the manufacturing procedure for increasing the illuminating efficiency.

Please refer to FIG. 1, the structure of a traditional lighting unit is shown. The structure of the traditional lighting unit has a base 102′, a light emitting body 106′, transparent encapsulating material 108′, fluorescence powders 110′ and a lens 112′. The fluorescence powders 110′ are uniformly coated on the interior surface of the lens 112′ by a multi-coating process. The position of the fluorescence powder 110′ is away from the light emitting body 106′ so that the light reflected back to the light emitting body 106′ are decreasing in order so as to avoid the loss of light. However, this manufacturing method has some disadvantages. The multi-coating process that is used for the coating of the fluorescence powders 110′ is a complex procedure so that the cost associated is increased. Furthermore, reflection is induced on the boundary of the encapsulating material thereby causing the lighting efficiency to be reduced.

The application of the lighting unit is restricted for the reason of complex manufacturing procedure and low lighting efficiency. Therefore, in view of this, the inventor proposes the present invention to overcome the above problems based on his expert experience and deliberate research.

### SUMMARY OF THE INVENTION

The primary object of the present invention is to provide an optimized manufacturing method and the product of the optimized manufacturing method having high illumination efficiency so that the application of the light emitting device is broadened.

In order to achieve the above object, the present invention provides a light emitting device. The light emitting device comprises a light emitting body; a base carrying the light emitting body; an encapsulating material covering the light emitting body; a wavelength conversion material mixing with the encapsulating material; and wherein the concentration of the wavelength conversion material within the encapsulating material is higher as the area is further from the light emitting body. Furthermore, the wavelength conversion material layer includes a plurality of first fluorescence powders. In other word, the concentration of the fluorescence powders of the wavelength conversion material layer has a variation such that the concentration of the fluorescence powders of the wavelength conversion material layer is higher as a distance between the fluorescence powders and the light emitting body is greater (i.e. within the encapsulating material area, the further the area is from the light body, the greater concentration of the fluorescence powders in that area). Furthermore, the light emitting device has a lens disposed on the light emitting body.

The present invention still provides another light emitting device. The light emitting device comprises a base having at least one lead frame; a light emitting body electrically arranged on the base and connected with the lead frame; a first encapsulating material formed on the light emitting body and the lead frame, wherein the first encapsulating material having a first wavelength conversion material layer with a plurality of first fluorescence powders. A concentration of the first fluorescence powders of the first wavelength conversion material layer gradually changes. The light emitting body is assembled on the lead frame of the base. The lead frame and the light emitting body are covered by the first encapsulating material which has the fluorescence powders therein. The first encapsulating material can be cured as a first wavelength conversion material layer. The concentration of the fluorescence powders of the first wavelength conversion material layer has a variation such that the concentration of the first fluorescence powders of the first wavelength conversion material layer is higher as a distance between the first fluorescence powders and the light emitting body is greater (i.e. within the encapsulating material, the further distance is from the light emitting body, the greater concentration of the fluorescence powders in that area). Furthermore, the light emitting device has a transparent encapsulating layer and a second wavelength conversion material layer.

In order to achieve the above objects, the present invention provides a manufacturing method for a light emitting device. The manufacturing method comprises the following step. Step (a) is mixing an encapsulating material and a wavelength conversion material into a mixture. Step (b) is filling the mixture into the base correspondingly to the light emitting body. Step (c) is curing the mixture, wherein a concentration of the wavelength conversion material is higher in the area of the mixture that is further away from the light emitting body. Furthermore, a step of reversing the light emitting device proceeds before step (c), thus further introduce a step of providing a fixing member, such as a lens or a molding for fixing the position the mixture correspondingly to the light emitting body before the reversing step.

The feature of the present invention is that the concentration of the wavelength conversion material layer has variation. For example, the concentration of the wavelength conversion material is higher at the higher space that is further from the light emitting body located at the bottom of the light emitting device. Accordingly, the reflection rate of the mixture mixed with the encapsulating material and the wavelength conversion material has gradual variation. Therefore, the total reflection on the boundary is reduced and the illumination efficiency is improved.

In order to better understand the characteristics and technical contents of the present invention, a detailed description thereof will be made with reference to accompanying drawings. However, it should be understood that the drawings and the description are illustrative only and are not used to limit the scope of the present invention.

### BRIEF DESCRIPTION OF THE DRAWINGS

FIG. 1 shows the light emitting device according to the prior art.

FIG. 2 shows the first embodiment of a light emitting device according to the present invention.

FIG. 3 shows the second embodiment of a light emitting device according to the present invention.

FIG. 4 shows the third embodiment of a light emitting device according to the present invention.

FIG. 5 shows the fourth embodiment of a light emitting device according to the present invention.

FIG. 6 shows the fifth embodiment of a light emitting device according to the present invention.

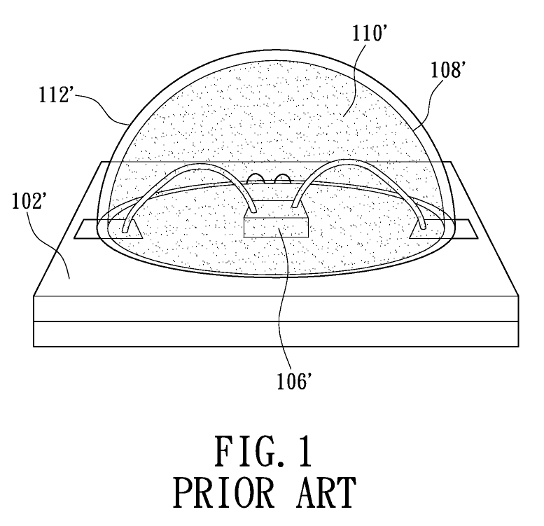

### DETAILED DESCRIPTION OF PREFERRED EMBODIMENTS

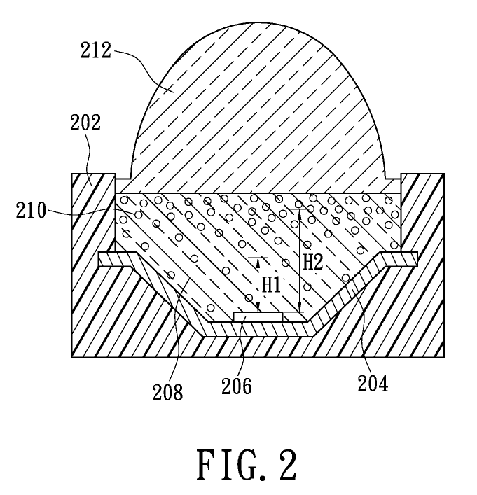

Please refer to FIG. 2, the present invention discloses a light emitting device and FIG. 2 shows the first embodiment of the light emitting device. The light emitting device includes a light emitting body 206, a base 202, an encapsulating material 208, and a wavelength conversion material 210 (i.e. a plurality of fluorescence powders). The base 202 is used for carrying the light emitting body 206, and the encapsulating material 208 covers the light emitting body 206. Furthermore, the wavelength conversion material 210 is mixed into the encapsulating material 208. The concentration of the wavelength conversion material 210 composed of a plurality of fluorescence powders changes according to the distance between the wavelength conversion material 210 and the light emitting body 206 thereby improving the lighting characteristics of the light emitting device. In this embodiment, when the wavelength conversion material 210 is farther away from the light emitting body 206, the concentration of the fluorescence powders of the wavelength conversion material 210 within the encapsulating material 208 is higher.

The base 202 of the light emitting device has at least one lead frame 204, please note that there is only one lead frame 204 illustrated for the simplicity but this particular number of lead frame is not meant to be limiting. The base 202 has a receiving room therein and the light emitting body 206 is assembled on the lead frame 204 in the receiving room. A lens 212 is assembled on the base 202 correspondingly to the light emitting body 206 (i.e. correspondingly to the light emitting body here means the center of the lens 212 aligns to the center of the light emitting body 206) and to the encapsulating material 208 (i.e. correspondingly to the encapsulating material 208 means the shape of the lens 212 corresponds to the shape of the encapsulating material 208). The mixture of the encapsulating material 208 and the wavelength conversion material 210 composed of a plurality of fluorescence powders is filled into the receiving room to cover the light emitting body 206. Moreover, the receiving room is defined as a chamber by the lens 212 and the base 202. In this embodiment, the light emitting body 206 is, but not restricted to, an LED (light emitting diode) and the encapsulating material is a thermosetting material. The feature of the present invention is that the concentration of the fluorescence powders of the wavelength conversion material 210 has a variation depending on the position of the fluorescence powders. For example, the concentration of the fluorescence powders of the wavelength conversion material 210 is higher in the area of the encapsulating material 208 that is further away from the light emitting body 206. As shown in FIG. 2, the distance H2 is greater than the distance HI in the encapsulating material 208, and it shows that the concentration of the wavelength conversion material 210 on H2 is higher than that on H1.

The manufacturing method of the light emitting device has the following steps. First, the light emitting body 206 is assembled on the lead frame 204 of the base 202. Next, the lens 212 is assembled on the base 202 and the chamber is defined. Next step is filling a mixture of an encapsulating material 208 and a wavelength conversion material 210 into the chamber defined by the lens 212 and the base 202. At last, the structure is reversed and then baked. When the structure is reversed, the wavelength conversion material 210 can be concentrated on the position away from the light emitting body 206. The encapsulating material 208 is cured to a baking temperature and to a baking time period. By the above-mentioned method, the structure has the concentration variation of higher wavelength conversion material concentration along the distance that is farther away from the light emitting body 206.

In addition, further has a mixing step for mixing the encapsulating material 208 and the wavelength conversion material 210 (i.e. a plurality of fluorescence powders) before or after assembling step according to process design.

The encapsulating material 208 is a thermosetting material such as glue material and the wavelength conversion material 210 can be mixed in the encapsulating material 208. The mixture of the encapsulating material 208 and the wavelength conversion material 210 is a curable composite material.

By reversing the structure of the light emitting device, the wavelength conversion material 210 composed of the fluorescence powders is concentrated on the bottom of the encapsulating material 208 (i.e. away from the light emitting body 206) because of the gravity. The light loss resulted from total reflection on the boundary is decreased because the reflection ratio has a gradual variation which is resulted from the higher concentration at the position farther away from the light emitting body 206. On the other hand, the fluorescence powders of the wavelength conversion material 210 are concentrated away from the light emitting body 206 so that the lighting efficiency of the light emitting device is improved.

As the aforementioned description, the structure and the manufacturing method have different types. However, the concentration of the wavelength conversion material 210 in the encapsulating material 208 is changeable and the reflection ratio has a gradual variation.

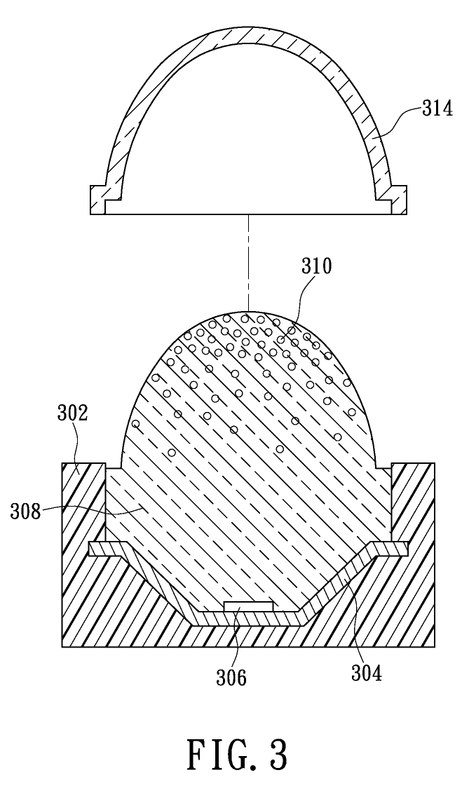

FIG. 3 shows the second embodiment of the light emitting device. The light emitting device includes a light emitting body 306, a base 302, an encapsulating material 308, and a wavelength conversion material 310 (i.e. a plurality of fluorescence powders). The base 302 has at least one lead frame 304 which is used for carrying the light emitting body 306, and the wavelength conversion material 310 is mixed into the encapsulating material 308. The mixture of the encapsulating material 308 and the wavelength conversion material 310 covers the light emitting body 306.

The manufacturing method of the second embodiment has the following steps. First, the light emitting body 306 is assembled on the lead frame 304 of the base 302. Next step is different from the first embodiment. A molding 314 shown in FIG. 3 is assembled on the base 302 and the chamber is defined. Next step is filling the mixture of the encapsulating material 308 and the wavelength conversion material 310 into the chamber defined by molding 314 and base 302. At last, the structure included the molding 314 is reversed and then baked. The molding 314 is released when the encapsulating material 308 cures. As result, the wavelength conversion material 310 can be concentrated at the position away from the light emitting body 306. By the above-mentioned method, the concentration of wavelength conversion material in close proximity to the light emitting body 306 is nearly equal to zero so that the light emitted form the light emitting body 306 can project light in higher density.

The encapsulating material 308 can be formed by two kinds of encapsulating materials. The first encapsulating material is disposed in close proximity to the light emitting body 306 as a transparent encapsulating layer and the second encapsulating material is disposed away from the light emitting body 306. In other words, the first and second encapsulating materials can be the same or different transparent glue material.

In addition, the manufacturing method of the second embodiment also can be a two-step method using two kinds of the encapsulating material 308. The second encapsulating material with the wavelength conversion material 310 composed of a plurality of fluorescence powders is filled into the molding 314 and the first encapsulating material without the wavelength conversion material 310 is filled into the receiving room of the base 302. Next, one of the first and second encapsulating materials is cured. Then assembling the molding 314 and the base 302 and curing the other encapsulating material. Alternatively, curing the other encapsulating material and then assembling the molding 314 and the base 302 is also accepted. However, the arc surface of the molding 314 always faces downward (i.e. reversing and baking step). At last, the molding 314 is released from the base 302 when the two encapsulating materials are totally cured.

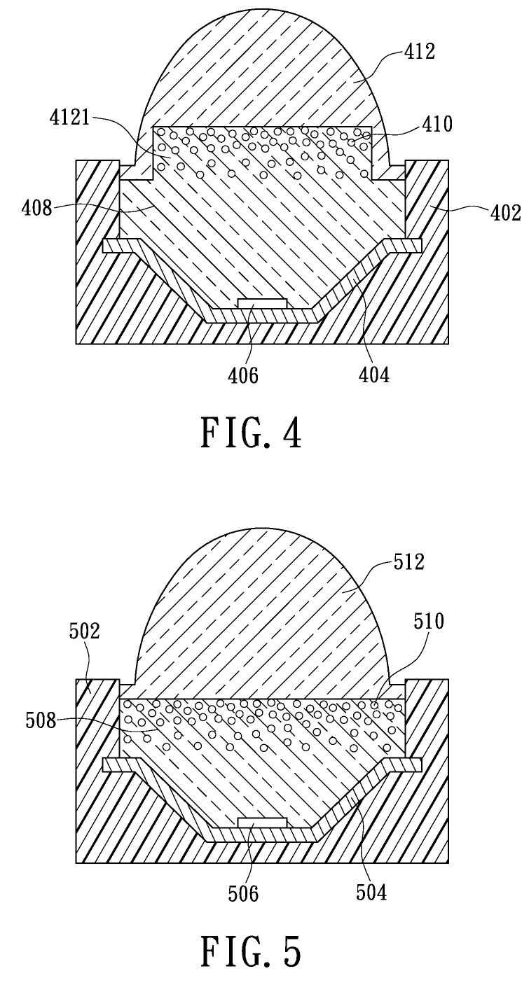

Please refer to FIG. 4, the third embodiment of the light emitting device is shown. The light emitting device includes a light emitting body 406, a base 402, an encapsulating material 408, a wavelength conversion material 410 and a lens 412. The base 402 has at least one lead frame 404 which is used for carrying the light emitting body 406, and the lens 412 has a concave area 4121, i.e., a trench concave down structure. The wavelength conversion material 410 is mixed into the encapsulating material 408. The mixture of the encapsulating material 408 and the wavelength conversion material 410 is filled into the concave area 4121 of the lens 412 or a space defined by the lens 412 with the concave area 4121 and the base 402. The composition of the wavelength conversion material 410 is higher under the condition that the wavelength conversion material 410 are closer to the bottom of the concave area 4121 (i.e. farther away from the light emitting body 406). Furthermore, the wavelength conversion material 410 concentrates within the concave area 4121. In other words, the composition of the wavelength conversion material 410 is almost zero in the area of the encapsulating material 408 except the concave area 4121 of the lens 412.

The manufacturing method of the third embodiment similar to the first embodiment has the following steps. First, the light emitting body 406 is assembled on the lead frame 404 of the base 402. Next, the lens 412 with concave area 4121 is assembled on the base 402 and a chamber is formed by the concave area 4121 of the lens 412 and a receiving room of the base 402. Next step is filling a mixture of an encapsulating material 408 and a wavelength conversion material 410 into the chamber defined by the lens 412 and the base 402. At last, the structure is reversed and then baked. When the structure is reversed, the wavelength conversion material 410 can be concentrated on the concave area 4121 of the lens 412, especially on the position away from the light emitting body 406. The encapsulating material 408 is cured to a baking temperature and to a baking time period.

The manufacturing method of the third embodiment can also be a method similar to the second embodiment using two kinds of the encapsulating material 408. A second encapsulating material mixed with a wavelength conversion material 410 composed of a plurality of fluorescence powders is filled into the concave area 4121 of the lens 412 and the concave area 4121 is full of the mixture of the second encapsulating material and the wavelength conversion material 410. Then, the lens 412 is reversed (i.e. the arc surface of the lens facing downward) for being baked. That is to say that the mixture filled the concave area is cured. As result, the composition of the wavelength conversion material 410 of the cured mixture is higher at the bottom of the concave area 4121 (i.e. farther away from the light emitting body 406). Next, the light emitting body 406 is assembled on the lead frame 404 of the base 402. Then, an optical structure combined the lens 412 and the cured mixture within thereof is assembled with the base 402 correspondingly to the light emitting body 406. Next, the first encapsulating material without the wavelength conversion material 410 is filled into the chamber defined by the optical structure and the base 402. At last, curing the first encapsulating material and then the lens 412 and the base 402 can be fixed.

Please refer to FIG. 5, which shows the fourth embodiment of the light emitting device. The light emitting device includes a light emitting body 506, a base 502, an encapsulating material 508, and a wavelength conversion material 510 composed of a plurality of fluorescence powders. The base 502 has at least one lead frame 504 which is used for carrying the light emitting body 506, and a lens 512 is assembled with the base 502 correspondingly to the top of the light emitting body 506 (i.e. lens 512 aligns so that its center corresponds to the top center of the light emitting body 506). The wavelength conversion material 510 is mixed into the encapsulating material 508 and the mixture is filled into the chamber defined by the lens 512 and the base 502. The concentration of the wavelength conversion material 510 is higher in area that is further away from the light emitting body 506. In this embodiment, the feature different from the first embodiment is that the concentration of the fluorescence powders of wavelength conversion material 510 are almost zero in the area in close proximity to the light emitting body 506.

The manufacturing method of the light emitting device has the following steps. First, the light emitting body 506 is assembled on the lead frame 504 of the base 502. Next step is filling the encapsulating material 508 into the receiving room of the base 502, however the receiving room is not filled full of the encapsulating material 508. Next step is curing the encapsulating material 508. Next, the lens 512 is assembled on the base 502 correspondingly to the light emitting body 506 (i.e. corresponds here means that the center of the lens 512 is in alignment with the center of the light emitting body 506). Then, mixing the encapsulating material 508 and the fluorescence powders 510, and the mixture of the encapsulating material 508 and the fluorescence powders 510 is filled into the remaining chamber space defined by lens 512 and base 502 (i.e. there is cured encapsulating material 508 inside the chamber). At last, the structure is reversed and then baked. By the above-mentioned method, the structure achieves fluorescence powder concentration variation, wherein the structure has higher fluorescence powder concentration within the area of encapsulating material 508 that is further away from the light emitting body 506.

The encapsulating material 508 can be of two kinds. The first encapsulating material is disposed in close proximity to the light emitting body 506 and the second encapsulating material is disposed away from the light emitting body 506. In other words, the first and second encapsulating materials can be the same or different transparent glue material.

The manufacturing method of the third embodiment can be a method using two kinds of the encapsulating material 508. First, the light emitting body 506 is assembled on the lead frame 504 of the base 502. Next step is filling the first encapsulating material into the receiving room of the base 502, however the receiving room is not filled full of the first encapsulating material. Next, the lens 512 is assembled on the base 502 correspondingly to the light emitting body 506 (i.e. the center of the lens is aligned to the center of the light emitting body). Then, the mixture of the second encapsulating material and the fluorescence powders 510 is filled into the remaining chamber space defined by lens 512 and base 502 (i.e. there is cured first encapsulating material inside the chamber). At last, the structure is reversed and then baked. By the above-mentioned method, the structure achieves fluorescence powder concentration variation, wherein the structure has higher fluorescence powder concentration within the area of encapsulating material 508 that is further away from the light emitting body 506.

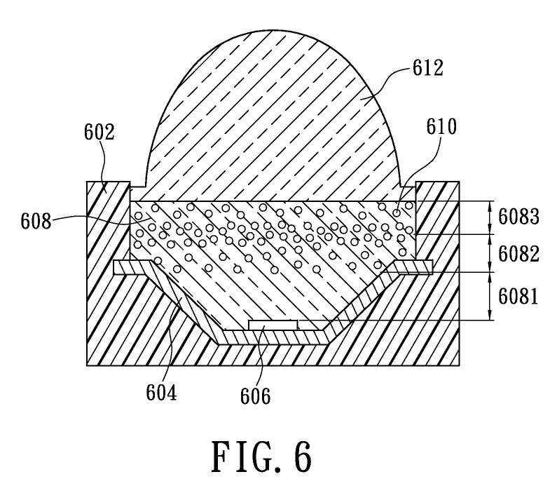

FIG. 6 shows the fifth embodiment of the light emitting device. The light emitting device includes a light emitting body 606, a base 602, an encapsulating material 608, and a plurality of fluorescence powders 610. The base 602 has at least one lead frame 604 which is used for carrying the light emitting body 606, and a lens 612 is assembled with the base 602 correspondingly to the light emitting body 606 (i.e. the center of the lens 612 is in alignment with the center of the light emitting body 606). The fluorescence powders 610 and the encapsulating material 608 are disposed in the chamber defined by the lens 612 and the base 602. The feature differs for the fifth embodiment is that the concentration of the fluorescence powders 610 increases and then decreases along the distance between the fluorescence powders 610 and the light emitting body 606. Furthermore, there is almost no fluorescence powder 610 in close proximity to the light emitting body 606. Alternatively, the concentration of the fluorescence powders 610 increases and then levels off as the distance between the fluorescence powders 610 and the light emitting body 606 is increasing.

The manufacturing method of the light emitting device of FIG. 6 has the following two steps. First, the light emitting body 606 is assembled on the lead frame 604 of the base 602, and the lens 612 is assembled on the base 602. Then, the fluorescence powders 610 and the encapsulating material 608 are mixed as a first mixture. Next is filling the first mixture into a first chamber defined by the base 602 and a chock (the lens 612 may be as a chock) however the first chamber is smaller than the receiving room of the base 602. Next is reversing the structure and then curing the first mixture as a first wavelength conversion material layer 6082 & 6081. In the first wavelength conversion material layer 6082 & 6081, the concentration of the fluorescence powders 610 increases as the distance to light emitting body 606 becomes greater. Next step is mixing the encapsulating material 608 and the fluorescence powders 610 as a second mixture and the concentration of the fluorescence powders 610 of the second mixture is lower than that of the first mixture. The second mixture is filled into a second chamber defined by the first wavelength conversion material layer 6082 & 6081 and the lens 612. At last, the structure is baked in order to form a second wavelength conversion material layer 6083 with a plurality of fluorescence powders 610 disposed on the first wavelength conversion material layer 6082. By the above-mentioned method, the structure has the concentration variation of the fluorescence powders 610 and the concentration of the fluorescence powders 610 increases and then decreases as the distance is increasing from the light emitting body 606.

In addition, the second chamber also can be defined by the first wavelength conversion material layer 6082 & 6081 and a molding. Then the second chamber is filled with the second mixture and then baked thereof. The molding is released when the second mixture cures. As result, the lens 612 is also formed as/with the second wavelength conversion material layer. By the above-mentioned method, the concentration of the fluorescence powders 610 decreases gradually from the interface of the first wavelength conversion material layer and the second wavelength conversion material layer 6083.

Another manufacturing method of the light emitting device of FIG. 6 has the following three steps. First, the light emitting body 606 is assembled on the lead frame 604 of the base 602, and the encapsulating material 608 is filled into the receiving room of the base 602 however the receiving room is not filled full of the encapsulating material 608. Next step is curing the encapsulating material 608 to form a transparent encapsulating layer 6081. Then, the chock (lens 612 may play as the chock) is assembled on the base 602. Then, the fluorescence powders 610 and the encapsulating material 608 are mixed as a first mixture. Next step is filling the first mixture into the first chamber defined by the transparent encapsulating layer 6081 and the chock; and the first chamber is smaller than the receiving room of the base 602. Next is reversing the structure and curing the first mixture as a first wavelength conversion material layer 6082 (i.e. the second step is used for forming the first wavelength conversion material layer 6082). In the first wavelength conversion material layer 6802, the concentration of the fluorescence powders 610 increases as the distance between the fluorescence powders 610 and the light emitting body 606 increases. Next step is mixing the encapsulating material 608 and the fluorescence powders 610 as a second mixture and the concentration of the second mixture is smaller than that of the first mixture. The second mixture is filled into a second chamber, the residual space of receiving room of the base 602(i.e. there are a transparent encapsulating layer 6801 and a first wavelength conversion material layer 6802 inside the room). At last, the structure is baked in order to cure the second mixture into a second wavelength conversion material layer 6083 (i.e. the third step is used for forming the second wavelength conversion material layer 6083). By the above-mentioned method, the structure achieves fluorescence powders concentration variation, wherein the fluorescence powders 610 and the concentration of the fluorescence powders 610 increases and then decreases as the distance between the fluorescence powders 610 and the light emitting body 606 is increasing.

In addition, the lens 612 of this embodiment also can have a concave area or another structure in the previous-mentioned embodiments.

Moreover, the multi-layer encapsulating structure which is formed by the first wavelength conversion material layer 6082 & 6081, and the second wavelength conversion material layer 6083 can be adopted at least two kinds of encapsulating materials. And the first wavelength conversion material layer includes a plurality of first fluorescence powders away from the light emitting body 606 and a first encapsulating material. The second wavelength conversion material layer 6083 is composed of a second encapsulating material and a plurality of second fluorescence powders disposed close to the interface of the two wavelength conversion material layer. That is to say, the first and second encapsulating materials can be the same or different transparent glue material. The concentration of the first fluorescence powders of the first wavelength conversion material layer gradually changes and the concentration of the second fluorescence powders of the second wavelength conversion material layer changes gradually.

In addition, the multi-layers encapsulating structure of the light emitting device also further includes a third wavelength conversion material layer with a plurality of third fluorescence powders disposed on the second wavelength conversion material layer, wherein the concentration of the third fluorescence powders on a side of the third wavelength conversion material layer that is in close to the second wavelength conversion material layer is lower than the concentration of the third fluorescence powders on an opposite side of the third wavelength conversion material layer that is further away from the first wavelength conversion material layer. In other words, the design of the multi-layers encapsulating structure depends on optical requirement.

The manufacturing method of the light emitting device of three encapsulating materials and three fluorescence powders has the following steps. First, the light emitting body 606 is assembled on the lead frame 604 of the base 602 and the lens 612 is assembled on the base 602. Next is filling a first mixture composed of the first fluorescence powders and the first encapsulating material into a first chamber defined by the base 602 and the chock (not shown in figure); then reversing the structure and curing the first mixture to form a first wavelength conversion material layer 6082 (i.e. the first step is used for forming the first wavelength conversion material layer 6082). In the first wavelength conversion material layer 6082, the concentration of the first fluorescence powders increases as the distance between the first fluorescence powders and the light emitting body 606 increases. Next step is filling a second mixture composed of the second fluorescence powders and the second encapsulating material into a space of receiving room of the base 602 and then curing the second mixture as a second wavelength conversion material layer 6083. Wherein, the second chamber can be as a part or all the residual space of receiving room of the base 602 (i.e. there is a first fluorescence layer inside the chamber) Next step is filling a third mixture composed of the third fluorescence powders and the third encapsulating material into a space defined by the second wavelength conversion material layer 6083 and a chock/a lens/a molding. At last, reversing the following structure and then baked it.

Furthermore, a transparent encapsulating material may be filled into the receiving room of the base 602 before the step of forming the first wavelength conversion material layer 6082; however the receiving room is not full of the transparent encapsulating material. Then, the transparent encapsulating material is cured. Therefore, the concentration of the fluorescence powders in close proximity to the light emitting body 606 is almost zero.

Furthermore, in all embodiments, the light emitting device includes a first electrical terminal and a second electrical terminal and the first and the second terminals are electrically and conductively connected to the light emitting body.

Although the present invention has been described with reference to the foregoing preferred embodiment, it shall be understood that the present invention is not limited to the details thereof. Various equivalent variations and modifications may occur to those skilled in this art in view of the teachings of the present invention. Thus, all such variations and equivalent modifications are also embraced within the scope of the present invention as defined in the appended claims.

What is claimed is:

1. A light emitting device, comprising:
a light emitting body;
a base carrying the light emitting body;
an encapsulating material covering the light emitting body;
a wavelength conversion material mixing with the encapsulating material; and
wherein the concentration of the wavelength conversion material within the encapsulating material is higher as the area is further from the light emitting body.

2. The light emitting device according to claim 1 further comprising a lens, wherein the lens is arranged correspondingly to the light emitting body.

3. The light emitting device according to claim 2, wherein the lens has a concave area and the encapsulating material are received inside the concave area.

4. The light emitting device according to claim 3, further comprising a transparent encapsulating layer disposed between the base and the encapsulating material.

5. The light emitting device according to claim 1, wherein the base further comprises a first electrical terminal and a second electrical terminal, the first and the second terminals are electrically and conductively connected to the light emitting body.

6. A light emitting device, comprising:
a base having at least one lead frame;
a light emitting body electrically arranged on the base and connected with the lead frame; and
a first encapsulating material formed on the light emitting body and the lead frame, the first encapsulating material having a first wavelength conversion material layer with a plurality of first fluorescence powders;
wherein a concentration of the first fluorescence powders of the first wavelength conversion material layer gradually changes.

7. The light emitting device according to claim 6, further comprising a second wavelength conversion material layer with a plurality of second fluorescence powders disposed on the first wavelength conversion material layer, wherein a concentration of the second fluorescence powders of the second wavelength conversion material layer changes gradually.

8. The light emitting device according to claim 7, wherein the concentration of the second fluorescence powders on a side of the second wavelength conversion material layer that is in close proximity to the first wavelength conversion material layer is higher than the concentration of the second fluorescence powders on an opposite side of the second wavelength conversion material layer that is further away from the first wavelength conversion material layer.

9. The light emitting device according to claim 8 further comprising a third wavelength conversion material layer with a plurality of third fluorescence powders disposed on the second wavelength conversion material layer, wherein the concentration of the third fluorescence powders on a side of the third wavelength conversion material layer that is in close to the second wavelength conversion material layer is lower than the concentration of the third fluorescence powders on an opposite side of the third wavelength conversion material layer that is further away from the first wavelength conversion material layer.

10. The light emitting device according to claim 7, further comprising a transparent encapsulating layer disposed between the base and the first wavelength conversion material layer.

11. The light emitting device according to claim 6, further comprising at least one lens, wherein the lens is arranged correspondingly to the light emitting body.

12. The light emitting device according to claim 11, wherein the lens has a concave area and the first wavelength conversion material layer are received inside the concave area.

13. The light emitting device according to claim 12, further comprising a transparent encapsulating layer disposed between the base and the first wavelength conversion material layer.

14. The light emitting device according to claim 12 further comprising a second wavelength conversion material layer with a plurality of second fluorescence powders disposed between the first wavelength conversion material layer and the base, wherein a concentration of the second fluorescence powders of the second wavelength conversion material layer changes gradually.

15. The light emitting device according to claim 14, wherein the concentration of the second fluorescence powders on a side of the second wavelength conversion material layer that is in close proximity to the base is lower than the concentration of the second fluorescence powders on an opposite side of the second wavelength conversion material layer that is further away from the base.

16. The light emitting device according to claim 15 further comprising a third wavelength conversion material layer with a plurality of third fluorescence powders disposed between the second wavelength conversion material layer, wherein the concentration of the third fluorescence powders on a side of the third wavelength conversion material layer that is in close to the second wavelength conversion material layer is higher than the concentration of the third fluorescence powders on an opposite side of the third wavelength conversion material layer that is further away from the first wavelength conversion material layer.

17. A manufacturing method for a light emitting device having a base, and a light emitting body disposed on the base, the manufacturing method comprising:
mixing an encapsulating material and a wavelength conversion material into a mixture;
filling the mixture into the base correspondingly to the light emitting body; and
curing the mixture, wherein a concentration of the wavelength conversion material is higher in the area of the mixture that is further away from the light emitting body.

18. The manufacturing method according to claim 17, further comprising a step for reversing the light emitting device before step (c).

19. The manufacturing method according to claim 18, further comprising a step for providing a fixing member for fixing the position the mixture correspondingly to the light emitting body before the reversing step.

20. The manufacturing method according to claim 19, wherein the fixing member is selected from a lens, a molding and a chock.
